(19) United States
(12) Patent Application Publication
(10) Pub. No.: US 2004/0224051 A1
(43) Pub. Date: Nov. 11, 2004

(54) Knockout cup for patty-forming machine

(76) Inventor: Ronald F. LaBruno, Mount Prospect, IL (US)

Correspondence Address: The Law Office Of Randall T. Erickson, P.C., 425 W. Wesley Street, Suite 1, Wheaton, IL, 60187, US

(21) Appl. No.: 10/435,616

(22) Filed: May 9, 2003

(51) Int. Cl. A22C 7/00

(52) U.S. Cl. 425/556; 425/575

(57) ABSTRACT

A patty-displacing end portion is provided for a plunger for a food patty-molding apparatus, the apparatus comprising an apparatus frame, a mold plate, the plunger and a heating element. The mold plate has at least one cavity and is mounted to reciprocate with respect to the frame in a longitudinal direction to position the cavity between a rearward, fill position wherein the cavity is filled with food product material to form a molded patty, and a forward, molded patty knockout position. The plunger has a patty-displacing end portion arranged to move vertically into the cavity to knock the molded patty out of the cavity. The heating element is typically arranged to heat the patty-displacing end portion to about 180 to 210° F. The patty-displacing end portion is composed of plastic. Preferably, the patty-displacing end portion is composed of a thermoplastic that retains structural strength up to 210° F. such as FDA & USDA approved solid polyester-semi-crystalline polyethylene terepthalate (PET-P) thermoplastic with a uniformly dispersed solid lubricant.

### TECHNICAL FIELD OF THE INVENTION

The present invention relates to food patty-molding machines. The invention particularly relates to food patty-molding machines which incorporate a reciprocating mold plate having one or more patty-forming cavities which are cyclically filled to form patties, and then emptied by action of one or more reciprocating knockout cups, the patties being discharged to a patty-receiving area.

### BACKGROUND OF THE INVENTION

Food patty-forming or molding machines are described, for example, in U.S. Pat. Nos. 6,454,559; 6,368,092; 3,887,964; 4,372,008 and 4,821,376. A known food patty-forming machine or apparatus 20 is illustrated in FIG. 1. This machine is described in detail in U.S. Pat. No. 3,887,964 and has been marketed as the FORMAX 26 machine by Formax, Inc., of Mokena, Ill. Molding machine 20 includes a machine base 21 which supports the operating mechanisms of the machine and contains hydraulic actuating systems, electrical actuating systems, and most of the machine controls.

The food patty-molding machine 20 includes a supply mechanism 24 for storing and supplying a moldable food product, such as ground beef, fish, pork, chicken, potatoes, or the like, to the processing mechanisms of the machine. Supply mechanism 24 includes a large food product storage hopper 25 that supplies a food pump system 26. System 26 includes two alternately operating food pumps (one shown); other machines typically include only a single food pump. The two food pumps continuously pump food, under pressure, into a valve manifold connected to a cyclically operable molding station 28. Molding station 28 includes a multi-cavity mold plate 32 that moves cyclically between a fill position, as shown in FIG. 1, and a discharge position in which its mold cavities are outside of station 28, aligned with a set of plungers having patty-displacing end portions in the form of knockout cups 33. The cups are sized and shaped to be slightly smaller than, but to closely conform to, the cavities in the mold plate.

Food supply mechanism 24 includes a conveyor belt 31 that extends completely across the bottom of hopper 25. In FIG. 1, a limited supply of food product 38 is shown in hopper 25; a much greater supply could be stored in the hopper without exceeding its capacity. The forward end of hopper 25 communicates with a vertical hopper outlet 39 that leads downwardly into two pump chambers; only one pump chamber 69 is shown. Three motors drive three vertical feed screws. Only one motor 47 and one feed screw 53 are shown in FIG. 1.

The upper part of a pump housing 71 comprises a plate 81 that supports the mold plate 32. The mold plate 32 includes a plurality of individual mold cavities 86 distributed in a single row or multiple rows across the width of the mold plate; mold cavities 86 are alignable with the manifold outlet fill passage 79. A mold cover 82 is disposed immediately above mold plate 32, closing off the top of each of the mold cavities 86. The mold cover 82 may include a conventional breather plate. Suitable spacers (not shown) are provided to maintain the spacing between the cover 82 and the support plate 81, essentially equal to the thickness of the mold plate 32. A housing 88 is positioned over the cover plate 82. The housing 88 encloses the operating mechanism (not shown) for reciprocating the knockout cups 33.

In the operation of the patty-molding machine 20, a supply of ground meat or other moldable food product 38 is placed into the hopper 25, and is advanced toward the hopper outlet 39 by the conveyor 31. Whenever one of the food pump plungers, such as the plunger 68, is retracted to expose a pump cavity (e.g., the cavity 69), the vertical feed screws 53 aligned with that pump cavity are actuated to feed the food product into the pump cavity.

In FIG. 1, pumping system 26 is illustrated with the mold plate 32 in its fill position, and with the pump 61 pumping the moldable food product through the manifold 27. The pump 61, as shown, has just begun its pumping stroke, and has compressed the food product in pump cavity 69, forcing it under pressure into the manifold 27. As operation of the machine 20 continues, the plunger 68 advances and food product flows into the mold cavities 126, there is a relatively constant pressure on the food product and chamber 69, manifold 27, fill passage 79, and cavities 86.

In each molding cycle, mold plate 32 remains in this fill position for a limited dwell interval. As the mold cavities 86 move into the fill position, one of the two food pumps of machine 20 pumps food product through manifold 27 and fill passage 79, filling the mold cavities. To assure complete filling of the mold cavities, the food pump must apply a substantial pressure to the food product.

Following the fill dwell interval, mold plate 32 is moved outwardly, to the right from its fill position, as shown in FIG. 1, until it reaches a discharge position with its mold cavities 86 aligned with knockout cups 33. As mold plate 32 moves toward its discharge position, mold cavities 86 all move clear of fill passage 79 before any part of those cavities projects out of mold station 28, beyond support plate 81 and cover 82. Thus, the food pump in machine 20, as shown in FIG. 1, remains sealed off at all times. A second dwell interval occurs at the discharge position of mold plate 32, during which knockout cups 33 move downwardly through the mold cavities, discharging the molded food patties onto a patty-receiving area, e.g. a take off conveyor (not shown).

Following discharge of the molded food patties, mold plate 32 is moved back toward its fill position so that mold cavities 86 can again be filled with food product. Again, mold cavities 86 are completely inside molding mechanism 28, sealed off, before they come into alignment with the fill passage 79.

For some food products a radiant heating element (not shown in FIG. 1) is used to heat the knockout cups 33 to an elevated temperature of between 180-210° F. in order to liquefy the fat in the food product, thereby facilitating release of patties from the cups at the bottom of knockout cup travel.

Known knockout cups for sliding mold plate type patty-forming machines are composed of aluminum material. Aluminum is used because it is a light weight and cost effective material that retains its strength at the elevated temperature of operation. However, because FDA & USDA rules and regulations prohibit raw aluminum to directly contact the food product, all aluminum knockout cups must be plated or coated with a barrier material. When the barrier material is either worn or damaged the cup needs to be reconditioned or replaced.

The present inventor has recognized that it would be desirable to provide a knockout cup for a patty-forming apparatus that did not require a barrier material to be plated or coated onto a base material. The present inventor has recognized that it would be desirable to provide a knockout cup for a patty-forming apparatus that was cost effectively produced and that would be durable in operation, especially considering the elevated operating temperature required of the knockout cup.

### SUMMARY OF THE INVENTION

The present invention provides an improved plunger for a food patty-forming apparatus having a mold plate with mold cavities adapted to be filled with food product to form patties, wherein the patties are removed from the cavities by action of the plunger, the plunger having a heated patty-displacing end portion. Preferably, the patty-displacing end portion has a perimeter that closely matches an inside perimeter of the cavity. According to one aspect of the invention, the patty-displacing end portion is composed of plastic.

Preferably, the patty-displacing end portion is composed of a thermoplastic that retains structural strength above 210° F. Preferably, the patty-displacing end portion is composed of polyester-semi-crystalline polyethylene terepthalate thermoplastic with a uniformly dispersed solid lubricant.

Preferably, the patty-displacing end portion is concave downward, having a rim portion sized to conform closely to a sidewall of the cavity and a patty-receiving area within the rim portion. The apparatus can comprise a heating element configured to heat the rim portion to a temperature greater than ambient temperature. The heating element can be configured to heat the rim portion to a temperature of between 180-210° F.

Preferably, the patty-displacing end portion is composed of polyester based thermoplastic. Preferably, the patty-displacing end portion is composed of polyethylene terepthalate based thermoplastic. More preferably the patty-displacing end portion is composed of solid polyester-semi-crystalline polyethylene terepthalate thermoplastic. Even more preferably, the patty-displacing end portion is composed of polyester-semi-crystalline polyethylene terepthalate thermoplastic with a uniformly dispersed solid lubricant.

According to the preferred embodiment of the invention, the improved knockout cup is manufactured from FDA & USDA approved solid polyester-semi-crystalline polyethylene terepthalate (PET-P) themoplastic with a uniformly dispersed solid lubricant. An aluminum base material with a plating or coating over the base material is not required. The material for the cups is suitable to use with the elevated temperature of the knockout cup caused by operation of the heating element.

The knockout cup of the invention is cost effectively produced and is sanitary, durable and operates effectively.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a diagrammatic sectional view of a prior art food patty-molding machine;

FIG. 2 is a diagrammatic fragmentary perspective view of a portion of a food patty forming machine incorporating the improvement of the present invention; and

FIG. 3 is a diagrammatic sectional view of a food patty-forming apparatus according to the present invention, with the apparatus mold plate in a knockout position.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

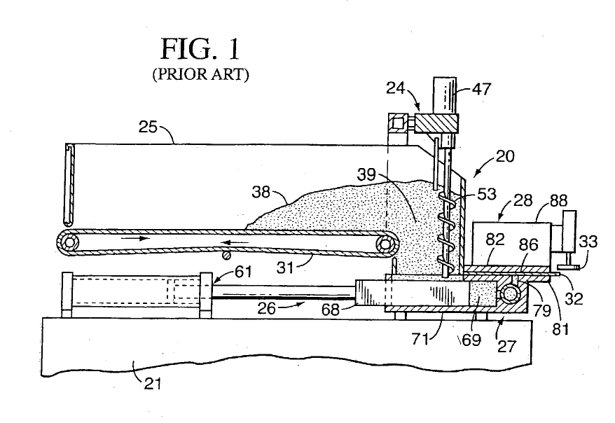

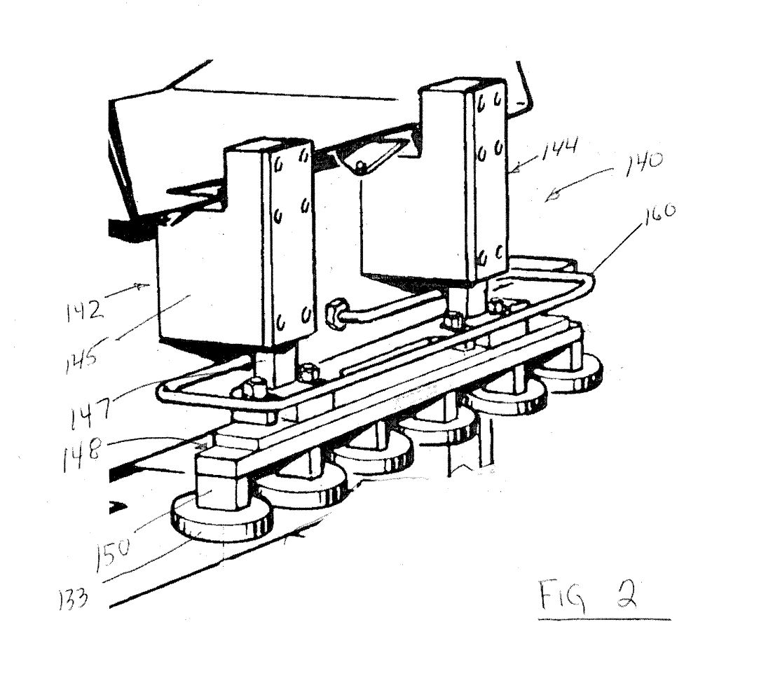

FIG. 2 illustrates a modified food patty-forming apparatus 120 of the present invention. Except as otherwise described herein, the apparatus 120 can be of a type such as described in U.S. Pat. Nos. 6,454,559; 6,368,092; 3,887,964; 4,372,008 and 4,821,376, herein incorporated by reference. Particularly, like components compared to the components of the prior art apparatus of FIG. 1 carry like reference numerals.

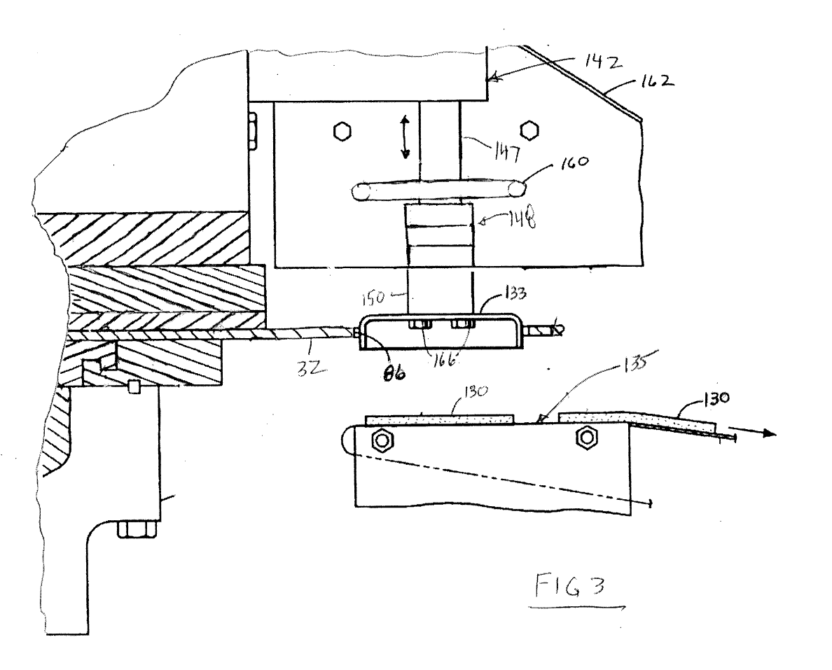

The apparatus 120 includes a mold plate 32 that moves cyclically between a fill position as shown in FIG. 1 and a discharge or knockout position as shown in FIG. 3. In the discharge position, a row of food patties 130 which occupy mold cavities 86 within the mold plate 32, are discharged by downward movement of a row of knockout cups 133. The food patties 130 can be delivered to a take-off conveyor 135 such as shown in FIG. 3.

FIG. 2 illustrates a knockout mechanism 140 that includes two knockout drive units 142,144. The drive units 142,144 can be configured in various known fashions such as those described in U.S. Pat. Nos. 6,368,092; 4,768,260; or 3,887,964, herein incorporated by reference. Each drive unit 142, 144 can include a rod housing 145 within which a reciprocating knockout rod 147 is at least partially enclosed. Each knockout rod 147 can be fastened to a knockout bar assembly 148.

A plurality of knockout support blocks 150 are mounted to a bottom side of the bar assembly 148 spaced apart along a length of the bar assembly. Each block 150 mounts one of the plurality of the knockout cups 133. The number and spacing of knockout cups 133 corresponds to the number and location of the plurality of the cavities 86, that are arranged in rows across a width of the mold plate 32.

A radiant electric heater 160 circumscribes the two knockout rods 147 and is located at an elevation approximately equal to the bar assembly 148 when fully elevated at the top of its reciprocating stroke. A heat deflector shield or hood 162 (shown in fragmentary fashion in FIG. 3) directs heat from the heater 160 to the cups 133. The heater 160 is configured to heat the knockout cups to an operating temperature of 180-210° F. depending on the food material being formed. A rheostat (not shown) is wired to the heater element 160 to manually set the temperature of the cups 133. A more sophisticated control system using a temperature sensor and an automatic adjustment can also be used.

FIG. 3 illustrates in section the configuration of the cups 133. Each cup 133 can be fastened to the respective support block 150 using a pair of fasteners 166. According to the invention, the cup 133 is composed of a plastic material. The plastic material preferably retains its structural strength above a working temperature of 180° F. and preferably above 210° F. Preferably, the cup 133 is composed of FDA and USDA compliant, solid polyester-semi-crystalline polyethylene terepthalate thermoplastic with a uniformly dispersed solid lubricant. Such a material is commercially available as ertalyte® TX from Erta N.V. Corporation, Belgium. The cup 133 can be molded or otherwise formed into a dished configuration, or alternately can be a sold disk or “puck.”

FIG. 3 illustrates the apparatus 120 with the mold plate 32 in the discharge or knockout stage or position. The knockout cups 133 are shown in a downward position, having just discharged patties 130 from cavities 86 respectively. The patties 130 can be deposited on the product conveyor 135 to move to a collection area for packaging.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

The invention claimed is:

1. In a food-patty forming apparatus having a mold plate with mold cavities adapted to be filled with food product to form patties, wherein said patties are removed from the cavities by action of a plunger having a heated patty-displacing end portion, the improvement comprising:
said patty-displacing end portion being composed of plastic.

2. The improvement according to claim 1, wherein said patty-displacing end portion is composed of polyester-semi-crystalline polyethylene terepthalate thermoplastic with a uniformly dispersed solid lubricant.

3. The improvement according to claim 1, wherein said patty-displacing end portion is concave downward, having a rim portion sized to conform closely to a sidewall of said cavity and a patty-receiving area within said rim portion.

4. The improvement according to claim 3, comprising a heating element configured to heat said rim portion to a temperature greater than ambient temperature.

5. The improvement according to claim 4, wherein said heating element is configured to heat said rim portion to a temperature of between 180-210° F.

6. The improvement according to claim 1 comprising a heating element configured to heat said patty-displacing end portion to a temperature greater than ambient temperature.

7. The improvement according to claim 6, wherein said heating element is configured to heat said patty-displacing end portion to a temperature of between 180-210° F.

8. A food patty-molding apparatus, comprising:
an apparatus frame;
a mold plate having at least one cavity and mounted to reciprocate with respect to said frame in a longitudinal direction to position said cavity between a rearward, fill position wherein said cavity is filled with food product material to form a molded patty, and a forward, molded patty knockout position;
a plunger having a patty-displacing end portion arranged to move vertically into said cavity to knock said molded patty out of said cavity, said patty-displacing end portion composed of plastic; and
a heating element arranged to heat said patty-displacing end portion to above ambient temperature.

9. The apparatus according to claim 8, wherein said patty-displacing end portion is composed of polyester-semi-crystalline polyethylene terepthalate thermoplastic.

10. The apparatus according to claim 8, wherein said patty-displacing end portion is concave downward, having a rim portion sized to conform closely to a sidewall of said cavity and a patty-receiving area within said rim portion.

11. The apparatus according to claim 10, wherein said heating element is configured to heat said rim portion to a temperature greater than ambient temperature.

12. The apparatus according to claim 11, wherein said heating element is configured to heat said rim portion to a temperature of between 180-210° F.

13. The apparatus according to claim 8, wherein said patty-displacing end portion has a perimeter that closely matches an inside perimeter of said cavity.

14. The apparatus according to claim 8, wherein said patty-displacing end portion is composed of polyester-semi-crystalline polyethylene terepthalate thermoplastic with a uniformly dispersed solid lubricant.

15. The apparatus according to claim 8, wherein said patty-displacing end portion is composed of polyester based thermoplastic.

16. The apparatus according to claim 8, wherein said patty-displacing end portion is composed of polyethylene terepthalate based thermoplastic.

17. The apparatus according to claim 8, wherein said patty-displacing end portion is composed of a thermoplastic that retains structural strength up to 210° F.
